(19) United States
(12) Patent Application Publication
(10) Pub. No.: US 2025/0200971 A1
(43) Pub. Date: Jun. 19, 2025

(54) PROCESSING APPARATUS, PROCESSING METHOD, AND NON-TRANSITORY STORAGE MEDIUM

(71) Applicant: NEC Corporation, Minato-ku, Tokyo (JP)

(72) Inventors: Noboru YOSHIDA, Tokyo (JP); Jianquan Liu, Tokyo (JP); Ryo Kawai, Tokyo (JP); Satoshi Yamazaki, Tokyo (JP); Tingting Dong, Tokyo (JP); Karen Stephen, Tokyo (JP); Youhei Sasaki, Tokyo (JP); Naoki Shindou, Tokyo (JP); Yuta Namiki, Tokyo (JP); Hiroaki Takeuchi, Tokyo (JP)

(73) Assignee: NEC Corporation, Minato-ku, Tokyo (JP)

(21) Appl. No.: 18/845,489

(22) PCT Filed: Mar. 23, 2022
(86) PCT No.: PCT/JP2022/013433

§ 371 Date: Sep. 10, 2024

(51) Int. Cl. G06V 20/52; G07F 19/00

(52) U.S. Cl. CPC G06V 20/52; G07F 19/207

(57) ABSTRACT

A processing apparatus (10) of the present invention includes: an action analysis unit (11) that detects that a target person captured in an image capturing a person in a facility performs any of a plurality of detection target actions; a determination unit (12) that determines a notification destination, based on at least one of a type of the detected detection target action, a position where the detected detection target action is performed, a time length for which the detected detection target action is performed, a time at which the detected detection target action is performed, and a certainty factor of a detection result; and a notification unit (13) that notifies the determined notification destination of detection of the detection target action.

### TECHNICAL FIELD

The present invention is related to a processing apparatus, a processing method, and a storage medium.

### BACKGROUND ART

A technique related to the present invention is disclosed in Patent Documents 1 to 3, and Non-Patent Document 1.

In Patent Document 1, it is disclosed a technique that analyzes an image capturing a user of an automatic teller machine (ATM), and in a case where it is decided that the user is being subjected or is highly likely to be subjected to a remittance fraud, notifies that matter to a monitoring center. Further, it is also disclosed that a notification destination is selected according to a degree of likelihood of being defrauded.

In Patent Document 2, it is disclosed a technique that analyzes an image capturing an ATM, and alerts in a case where it is detected that the user is in a phone call pose.

In Patent Document 3, it is disclosed a technique that computes a feature value of each of a plurality of key points of a human body included in an image, and based on the computed feature value, searches for an image including a human body in a similar pose or a human body of which motion is similar, and classifies images capturing the similar pose or the similar movement together.

A technique related to human skeleton estimation is disclosed in Non-Patent Document 1.

### RELATED DOCUMENT

### Patent Document

Patent Document 1: Japanese Patent Application Publication No. 2010-238204
Patent Document 2: Japanese Patent Application Publication No. 2010-176531
Patent Document 3: International Patent Publication No. WO2021/084677

### Non-Patent Document

Non-Patent Document 1: Zhe Cao, Tomas Simon, Shih-En Wei, Yaser Sheikh, “Realtime Multi-Person 2D Pose Estimation using Part Affinity Fields”, The IEEE Conference on Computer Vision and Pattern Recognition (CVPR), 2017, pp. 7291 to 7299

### DISCLOSURE OF THE INVENTION

### Technical Problem

Through an image analysis, it is possible to detect a person performing various actions, such as a person talking on a mobile phone, a person moving using a wheelchair, a person moving using a white cane. By notifying detection of a person performing a predetermined action of an appropriate notification destination in response to the detection, prevention of an incident, improvement of service quality, and the like is achieved.

A means for selecting a notification destination according to a degree of likelihood of being defrauded disclosed in Patent Document 1 is not usable except in a case of being likely to be defrauded. Specifically, there is a problem that it can only be used in limited situations. Patent Documents 2 and 3 and Non-Patent Document 1 do not disclose an issue of notifying appropriate information to an appropriate notification destination and means for achieving this.

One example of an object of the present invention is to provide, in view of the above-described problem, a processing apparatus, a processing method, and a storage medium that solve an issue of notifying an appropriate notification destination according to detection of a person performing a predetermined action.

### Solution to Problem

According to one aspect of the present invention, a processing apparatus is provided, including:
an action analysis unit that detects that a target person captured in an image capturing a person in a facility performs any of a plurality of detection target actions;
a determination unit that determines a notification destination, based on at least one of a type of the detected detection target action, a position where the detected detection target action is performed, a time length for which the detected detection target action is performed, a time at which the detected detection target action is performed, and a certainty factor of a detection result; and
a notification unit that notifies the determined notification destination of detection of the detection target action.

According to one aspect of the present invention, a processing method is provided, including,
by a computer:
detecting that a target person captured in an image capturing a person in a facility performs any of a plurality of detection target actions;
determining a notification destination, based on at least one of a type of the detected detection target action, a position where the detected detection target action is performed, a time length for which the detected detection target action is performed, a time at which the detected detection target action is performed, and a certainty factor of a detection result; and
notifying the determined notification destination of detection of the detection target action.

According to one aspect of the present invention, a storage medium is provided, storing a program causing a computer to function as:
an action analysis unit that detects that a target person captured in an image capturing a person in a facility performs any of a plurality of detection target actions;
a determination unit that determines a notification destination, based on at least one of a type of the detected detection target action, a position where the detected detection target action is performed, a time length for which the detected detection target action is performed, a time at which the detected detection target action is performed, and a certainty factor of a detection result; and
a notification unit that notifies the determined notification destination of detection of the detection target action.

### Advantageous Effects of Invention

According to one aspect of the present invention, a processing apparatus, a processing method, and a storage medium that solves an issue of notifying an appropriate notification destination according to detection of a person performing a predetermined action are achieved.

### BRIEF DESCRIPTION OF THE DRAWINGS

The above-described object, other objects, a feature, and an advantage is further clarified by public example embodiments described below and drawings accompanying thereto.

FIG. 1 It is a diagram illustrating one example of a functional block diagram of a processing apparatus.

FIG. 2 It is a diagram illustrating one example of a functional block diagram of a processing system.

FIG. 3 It is a diagram illustrating a specific example of a functional block diagram of the processing system.

FIG. 4 It is a diagram illustrating one example of a hardware configuration of the processing apparatus.

FIG. 5 It is a diagram for describing processing performed by an action analysis unit.

FIG. 6 It is a diagram schematically illustrating one example of information to be processed by the processing apparatus.

FIG. 7 It is a flowchart illustrating one example of a flow of processing performed by the processing apparatus.

FIG. 8 It is a diagram schematically illustrating one example of information to be processed by the processing apparatus.

FIG. 9 It is a flowchart illustrating one example of a flow of processing performed by the processing apparatus.

### EXAMPLE EMBODIMENT

In the following, example embodiments of the present invention are described with reference to the drawings. Note that, in all the drawings, similar component is denoted with similar reference sign, and description thereof is omitted as appropriate.

### First Example Embodiment

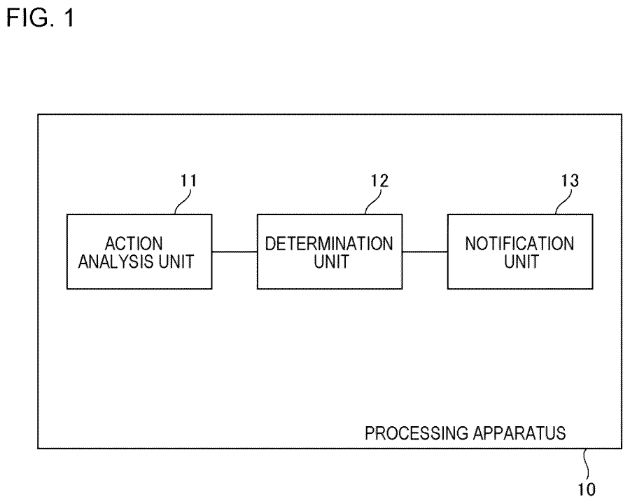

FIG. 1 is a functional block diagram illustrating an outline of a processing apparatus 10 according to a first example embodiment. The processing apparatus 10 includes an action analysis unit 11, a determination unit 12, and a notification unit 13.

The action analysis unit 11 detects that a target person captured in an image capturing a person in a facility performs any of a plurality of detection target actions. The determination unit 12 determines a notification destination, based on at least one of a type of the detected detection target action, a position where the detected detection target action is performed, a time length for which the detected detection target action is performed, a time at which the detected detection target action is performed, and a certainty factor of a detection result. The notification unit 13 notifies the determined notification destination of detection of the detection target action.

According to the processing apparatus 10 configured in this way, an issue of notifying an appropriate notification destination according to detection of a person performing a predetermined action is solved.

### Second Example Embodiment

### “Outline”

A processing apparatus 10 according to a second example embodiment is a more specific version of the processing apparatus 10 according to the first example embodiment.

### “Overall View of Processing System Including Processing Apparatus 10”

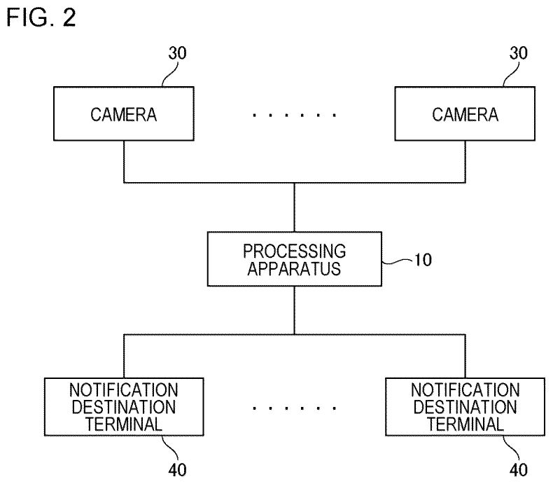

One example of a functional block diagram of a processing system is illustrated in FIG. 2. As illustrated in FIG. 2, the processing system includes the processing apparatus 10, a camera 30, and a notification destination terminal 40.

The camera 30 is installed in a facility. The facility varies including a bank, a post office, a supermarket, a convenience store, a department store, an amusement park, a building, a station, an airport, and the like, and details thereof are not specifically limited. Although a plurality of the cameras 30 are illustrated in FIG. 2, one camera 30 may be installed in the facility, or the plurality of cameras 30 may be installed in the facility. The camera 30 is installed, for example, at an entrance/exit of the facility, at a place where a predetermined device is installed in the facility, in an area leading to a staircase, and the like. Note that, an installation position of the camera 30 exemplified herein is merely one example, and is not limited thereto. The camera 30 may capture a moving image, or may capture a still image at predetermined timing determined in advance.

The processing apparatus 10 analyzes an image generated by the camera 30, and detects that a target person captured in the image performs any of a plurality of predetermined detection target actions. Next, the processing apparatus 10 determines a notification destination of a detection result, based on at least one of a type of the detected detection target action, a position where the detected detection target action is performed, a time length for which the detected detection target action is performed, a time at which the detected detection target action is performed, and a certainty factor of the detection result. Then, the processing apparatus 10 notifies the determined notification destination of the detection result. Any of a plurality of the notification destination terminals 40 is determined as the notification destination. Note that, details of processing performed by the processing apparatus 10 is described later.

The notification destination terminal 40 is a terminal being the notification destination of the detection result. The notification destination terminal 40 is a smartphone, a tablet terminal, a mobile phone, a personal computer, a dedicated terminal, a digital signage, or the like, but is not limited thereto. The processing apparatus 10 transmits the detection result to the notification destination terminal 40 being the determined notification destination. The notification destination terminal 40 outputs predetermined information in response to notification from the processing apparatus 10.

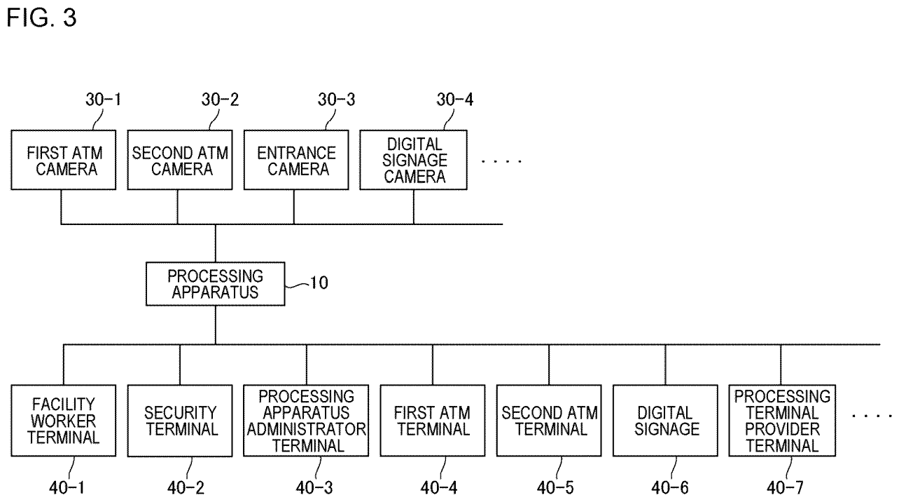

Next, a specific example of the processing system according to the second example embodiment is described with reference to FIG. 3. Note that, the specific example illustrated in FIG. 3 is merely one example, and a configuration of the processing system is not limited thereto.

A facility in this example is a facility in which an automatic teller machine (ATM) is installed. For example, examples include a bank, a post office, a convenience store, a supermarket, a department store, and the like, but are not limited thereto.

The camera 30 is installed for each ATM, and captures a user of each ATM. A first ATM camera 30-1 and a second ATM camera 30-2 are illustrated in FIG. 3. The first ATM camera 30-1 captures a user of a first ATM. The second ATM camera 30-2 captures a user of the second ATM. Although two cameras 30 for ATMs are illustrated in FIG. 3, the number of the cameras 30 is not limited thereto.

Further, the camera 30 may be installed at a position where a person at another position in the facility is captured. For example, examples include an entrance camera 30-3 that captures a person near an entrance of the facility, a digital signage camera 30-4 that captures a person near a digital signage installed in the facility, and the like, but are not limited thereto.

As illustrated in FIG. 3, the notification destination terminal 40 may include at least one of a facility worker terminal 40-1, a security terminal 40-2, a processing apparatus administrator terminal 40-3, a first ATM terminal 40-4, a second ATM terminal 40-5, a digital signage 40-6, and a processing apparatus provider terminal 40-7.

The facility worker terminal 40-1 is a terminal used by a worker of the facility (a worker who attends a visitor, and the like). A worker of the facility is notified of a result of detection by the processing apparatus 10, specifically, notified that a person performing a predetermined detection target action is detected, via the facility worker terminal 40-1. The facility worker terminal 40-1 is a smartphone, a tablet terminal, a mobile phone, a personal computer, a dedicated terminal, or the like. Note that, the processing apparatus 10 may transmit the detection result to the facility worker terminal 40-1. Alternatively, the processing apparatus 10 may transmit the detection result to a server of the facility, and the server of the facility may transmit the detection result to the facility worker terminal 40-1. Further, the result of detection by the processing apparatus 10 may be transmitted to the facility worker terminal 40-1 via another route.

The security terminal 40-2 is a terminal used by a security guard or a person related to a security organization (security company and the like). A security guard or a person related to the security organization (security company and the like) is notified of the result of detection by the processing apparatus 10, specifically, notified that a person performing a predetermined detection target action is detected, via the security terminal 40-2. The security terminal 40-2 is a smartphone, a tablet terminal, a mobile phone, a personal computer, a dedicated terminal, or the like. Note that, the processing apparatus 10 may transmit the detection result to the security terminal 40-2. Alternatively, the processing apparatus 10 may transmit the detection result to a server of the security organization (security company and the like), and the server of the security organization (security company and the like) may transmit the detection result to the security terminal 40-2. Further, the result of detection by the processing apparatus 10 may be transmitted to the security terminal 40-2 via another route.

The processing apparatus administrator terminal 40-3 is a terminal used by an administrator (a person in charge of the facility, and the like) who manages (performs maintenance, repair, and the like) the processing apparatus 10. An administrator who manages the processing apparatus 10 is notified of the result of detection by the processing apparatus 10, specifically, notified that a person performing a predetermined detection target action is detected, via the processing apparatus administrator terminal 40-3. The processing apparatus administrator terminal 40-3 is a smartphone, a tablet terminal, a mobile phone, a personal computer, a dedicated terminal, or the like. Note that, the processing apparatus 10 may transmit the detection result to the processing apparatus administrator terminal 40-3. Alternatively, the processing apparatus 10 may transmit the detection result to a server of an organization to which an administrator who manages the processing apparatus 10 belongs, and the server may transmit the detection result to the processing apparatus administrator terminal 40-3. Further, the result of detection by the processing apparatus 10 may be transmitted to the processing apparatus administrator terminal 40-3 via another route.

The first ATM terminal 40-4 and the second ATM terminal 40-5 are terminals that provide a notification to a user of an ATM. The notification destination terminal 40 is provided for each ATM. Each of the first ATM terminal 40-4 and the second ATM terminal 40-5 may be an ATM itself, or may be an output apparatus installed near the ATM. Examples of the output apparatus include a speaker, a display, a warning lamp, and the like. Note that, the processing apparatus 10 may transmit the detection result to each of the first ATM terminal 40-4 and the second ATM terminal 40-5. Alternatively, the processing apparatus 10 may transmit the detection result to a server of the facility, and the server of the facility may transmit the detection result to each of the first ATM terminal 40-4 and the second ATM terminal 40-5. Further, the result of detection by the processing apparatus 10 may be transmitted to each of the first ATM terminal 40-4 and the second ATM terminal 40-5 via another route.

The digital signage 40-6 is a terminal that provides a notification and other information to a visitor of the facility. The digital signage 40-6 is installed at any position in the facility. Note that, the processing apparatus 10 may transmit the detection result to the digital signage 40-6. Alternatively, the processing apparatus 10 may transmit the detection result to a server of the facility, and the server of the facility may transmit the detection result to the digital signage 40-6. Further, the result of detection by the processing apparatus 10 may be transmitted to the digital signage 40-6 via another route.

The processing apparatus provider terminal 40-7 is a terminal used by a person in charge in a provider (a manufacturer or a vendor of the processing apparatus 10) that has provided the processing apparatus 10 and the like. A person in charge in the provider that has provided the processing apparatus 10 is notified of the result of detection by the processing apparatus 10, specifically, notified that a person performing a predetermined detection target action is detected, via the processing apparatus provider terminal 40-7. The processing apparatus provider terminal 40-7 is a smartphone, a tablet terminal, a mobile phone, a personal computer, a dedicated terminal, or the like. Note that, processing apparatus 10 may transmit the detection result to the processing apparatus provider terminal 40-7. Alternatively, the processing apparatus 10 may transmit the detection result to a server of the provider that has provided the processing apparatus 10, and the server may transmit the detection result to the processing apparatus provider terminal 40-7. Further, the result of detection by the processing apparatus 10 may be transmitted to the processing apparatus provider terminal 40-7 via another route.

### “Hardware Configuration”

Next, one example of a hardware configuration of the processing apparatus 10 is described. Each functional unit of the processing apparatus 10 is achieved by a combination of hardware and software, mainly including a central processing unit (CPU) of any computer, a memory, a program loaded onto the memory, a storage unit, such as a hard disk, storing the program (in addition to a program stored in advance from a stage of shipping an apparatus, a program downloaded from a storage medium such as a compact disk (CD) or from a server on the Internet can also be stored), and an interface for network connection. Further, it is understood by a person skilled in the art that there are various modification example of a method and an apparatus for achieving the processing apparatus 10.

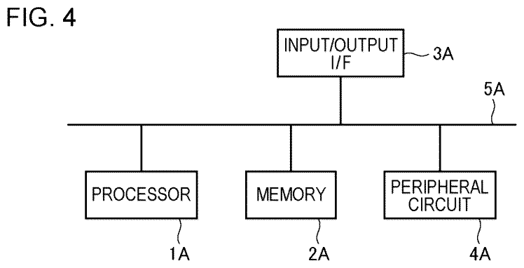

FIG. 4 is a block diagram illustrating the hardware configuration of the processing apparatus 10. As illustrated in FIG. 4, the processing apparatus 10 includes a processor 1A, a memory 2A, an input/output interface 3A, a peripheral circuit 4A, and a bus 5A. The peripheral circuit 4A includes various modules. The processing apparatus 10 may not include the peripheral circuit 4A. Note that, the processing apparatus 10 may be configured of a plurality of apparatuses that are physically and/or logically separated. In this case, each of the plurality of apparatuses may have the above-described hardware configuration.

The bus 5A is a data transmission path for the processor 1A, the memory 2A, the peripheral circuit 4A, and the input/output interface 3A to mutually transmit and receive data. The processor 1A is, for example, an arithmetic processing apparatus such as a CPU, a graphics processing unit (GPU), and the like. The memory 2A is, for example, a memory such as a random access memory (RAM), a read only memory (ROM), and the like. The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, and the like. The output apparatus is, for example, a display, a speaker, a printer, a mailer, and the like. The processor 1A can issue an instruction to each module, and perform arithmetic operation based on a result of arithmetic operation by the module.

### “Functional Configuration”

Next, a functional configuration of the processing apparatus 10 according to the second example embodiment is described in detail. One example of a functional block diagram of the processing apparatus 10 according to the second example embodiment is illustrated in FIG. 1. As illustrated, the processing apparatus 10 includes an action analysis unit 11, a determination unit 12, and a notification unit 13.

The action analysis unit 11 detects that a person (hereinafter, referred to as a “target person”) captured in an image generated by the camera 30, specifically, an image capturing a person in the facility, performs any of a plurality of detection target actions.

The “detection target action” is an action being desired to be detected for a purpose of preventing an incident, improving quality of a service provided by the facility, and the like. For example, the detection target action may include at least one of talking on a mobile phone, an action of operating an ATM while talking on a mobile phone, moving using a wheelchair, moving using a white cane, and an action of showing an interest in a predetermined material (a brochure, a catalog, an advertisement, a leaflet, and the like) placed in the facility. The action of showing an interest in a predetermined material is an action of reaching for the predetermined material, an action of picking up the predetermined material, an action of looking at the predetermined material, an action of looking at the predetermined material for a predetermined time or longer, and the like.

By detecting talking on a mobile phone and the action of operating an ATM while talking on a mobile phone, prevention of an incident such as a remittance fraud is achieved. By detecting moving using a wheelchair and moving using a white cane and assisting such a visitor, improvement of service quality, and the like are achieved. Further, by detecting the action of showing an interest in a predetermined material placed in the facility and providing such a visitor with appropriate information, improvement of service quality, and the like are achieved.

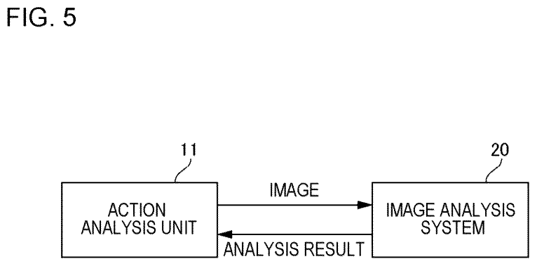

By analyzing an image, it can be detected that the target person performs the detection target action. An image analysis is performed by an image analysis system 20 prepared in advance. As illustrated in FIG. 5, the action analysis unit 11 inputs an image to the image analysis system 20. Then, the action analysis unit 11 acquires an analysis result from the image analysis system 20. The image analysis system 20 may be a part of the processing apparatus 10, or may be an external apparatus being physically and/or logically independent from the processing apparatus 10.

Herein, the image analysis system 20 is described. The image analysis system 20 includes at least one of a face recognition function, a human form recognition function, a pose recognition function, a motion recognition function, an external attribute recognition function, a gradient feature detection function of an image, a color feature detection function of an image, an object recognition function, a character recognition function, and a visual line detection function.

The face recognition function extracts a face feature value of a person. Furthermore, a similarity between face feature values may be collated and computed (decision as to whether it is the same person, and the like). Further, the extracted face feature value may be collated with face feature values of a plurality of users preliminarily registered in a database, and which user is a person captured in an image may be determined.

The human form recognition function extracts a human body feature value of a person (for example, overall characteristics such as a body shape i.e., obese or thin, a body height, clothing, and the like). Furthermore, a similarity between human body feature values may be collated and computed (decision as to whether it is the same person, and the like). Further, the extracted human body feature value may be collated with human body feature values of a plurality of users preliminarily registered in a database, and which person is a person captured in an image may be determined.

The pose recognition function and the motion recognition function detect a joint point of a person, and configure a stick human model by connecting the joint points. Then, based on the stick human model, a person is detected, a body height of the person is estimated, a pose of the person is determined, and a motion is determined based on a change of a pose. For example, a pose of talking on a mobile phone and an action of talking on a mobile phone, a pose and an action of operating an ATM, a pose and an action of moving using a wheelchair, a pose and an action of moving using a white cane, a pose and an action of reaching for a material, a pose and an action of picking up a material, and the like are determined. Furthermore, a similarity between pose feature values, and a similarity between motion feature values may be collated and computed (decision as to whether it is the same pose and the same motion, and the like). Further, the estimated body height may be collated with body heights of a plurality of users preliminarily registered in a database, and which user is a person captured in an image may be determined. The pose recognition function and the motion recognition function may be achieved by using the technique disclosed in the above-described Patent Document 3 and Non-Patent Document 1.

The external appearance attribute recognition function recognizes an external appearance attribute associated with a person (for example, there are 100 or more types of external appearance attribute, such as a clothing color, a shoe color, a hair style, wearing a hat, a necktie, and the like). Furthermore, a similarity between the recognized external appearance attributes may be collated and computed (decision as to whether it is the same attribute is possible). Further, the recognized external appearance attribute may be collated with external appearance attributes of a plurality of users preliminarily registered in a database, and which user is a person captured in an image may be determined.

The gradient feature detection function of an image is SIFT, SURF, RIFF, ORB, BRISK, CARD, HOG, and the like. A gradient feature of each frame image is detected by the function.

The color feature detection function of an image generates data indicating a feature of a color of an image, such as a color histogram. A color feature of each frame image is detected by the function.

The object recognition function is achieved, for example, by using an engine such as YOLO (capable of extracting a general object [for example, a tool and equipment used in a sport or another performance, and the like], and extracting a person). By using the object recognition function, various objects can be detected from an image. For example, a wheelchair, a white cane, a mobile phone, a predetermined material, and the like may be detected.

The character recognition function recognizes a number, a letter, and the like captured in an image.

The visual line detection function detects a direction of sight of a person captured in an image. Based on the detected direction of sight and an in-image position of a detected predetermined material, it can be detected that the person looks at the material.

The action analysis unit 11 detects, based on an analysis result received from the above-described image analysis system 20, that the target person performs any of the plurality of detection target actions.

Returning back to FIG. 1, the determination unit 12 determines a notification destination, based on at least one of a type of the detected detection target action, a position where the detected detection target action is performed, a time length for which the detected detection target action is performed, a time at which the detected detection target action is performed, and a certainty factor of a detection result. For example, the determination unit 12 may determine a notification destination, based on at least two of the type of the detected detection target action, the position where the detected detection target action is performed, the time length for which the detected detection target action is performed, the time at which the detected detection target action is performed, and the certainty factor of the detection result. Alternatively, the determination unit 12 may determine a notification destination, based on at least three of the type of the detected detection target action, the position where the detected detection target action is performed, the time length for which the detected detection target action is performed, the time at which the detected detection target action is performed, and the certainty factor of the detection result. Alternatively, the determination unit 12 may determine a notification destination, based on all of the type of the detected detection target action, the position where the detected detection target action is performed, the time length for which the detected detection target action is performed, the time at which the detected detection target action is performed, and the certainty factor of the detection result.

A plurality of notification destinations are defined in advance. Then, the determination unit 12 determines a notification destination from among the plurality of notification destinations. For example, the plurality of notification destinations defined in advance may include at least one of the facility worker terminal 40-1, the security terminal 40-2, the processing apparatus administrator terminal 40-3, and a visitor terminal that is installed in the facility and outputs information toward a person in the facility. The visitor terminal includes at least one of the first ATM terminal 40-4, the second ATM terminal 40-5, and the digital signage 40-6.

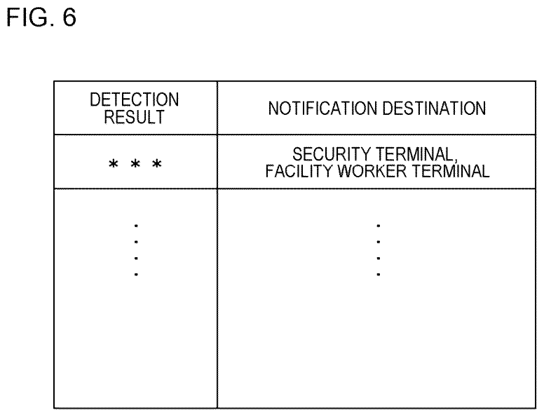

As illustrated in FIG. 6, first association information in which a detection result and a notification destination are associated is generated and stored in the processing apparatus 10 in advance. The determination unit 12 determines, based on a result of detection by the action analysis unit 11 and the first association information, a notification destination according to the detection result.

Note that, the result of detection by the action analysis unit 11 includes at least one of a type of the detected detection target action, a position where the detected detection target action is performed, a time length for which the detected detection target action is performed, a time at which the detected detection target action is performed, and a certainty factor of the detection result.

The “type of the detected detection target action” indicates any of the plurality of detection target actions defined in advance.

The “position where the detected detection target action is performed” indicates a position in the facility where a person performing the detected detection target action is located. For example, an installation position of the camera 30 that generates an image from which the detection target action is detected may be indicated as the position where the detected detection target action is performed.

The “time length for which the detected detection target action is performed” indicates a time length for which a person performing the detected detection target action continues performing the detection target action. The time length may be a time length for which a specific person continues performing a predetermined detection target action (e.g., an action of operating an ATM while talking on a mobile phone) in an image captured by one camera. Alternatively, a time length for which a specific person continues performing a predetermined detection target action (e.g., talking on a mobile phone) in the facility may be computed based on a result of analyzing images captured by a plurality of cameras installed in the facility. The latter case is achieved, for example, by processing described below. First, the action analysis unit 11 determines a person captured across a plurality of images captured by the plurality of cameras, by using an external appearance feature value (face information and the like) of the person. Then, in a case where the person detected to be performing the predetermined detection target action (e.g., talking on a mobile phone) in a first image goes out of a frame of the first image while continuing performing the predetermined detection target action and comes into a frame of a second image while continuing performing the predetermined detection target action, the action analysis unit 11 may compute the above-described time length assuming that the predetermined detection target action is also continuously performed between a time at which the person goes out of the frame of the first image and a time at which the person comes into the frame of the second image. Note that, the above-described time length may be computed assuming that the predetermined detection target action is also continuously performed between the time at which the person goes out of the frame of the first image and the time at which the person comes into the frame of the second image, in a case where a condition that “a time from the person goes out of the frame of the first image until the person comes into the frame of the second image is equal to or less than a predetermined time” is satisfied.

The “time at which the detected detection target action is performed” indicates a time at which a person performing the detected detection target action performs the detection target action.

The “certainty factor of the detection result” indicates a certainty factor that the detected detection target action is performed. For example, a certainty factor of a pose and a motion detected by the pose recognition function and the motion recognition function may be set as the certainty factor of the detection result. Alternatively, a result of integrating (e.g., averaging, weighted averaging, and the like), by using a predetermined method, a certainty factor of a pose and a motion detected by the pose recognition function and the motion recognition function and a certainty factor of an object (a mobile phone, a wheelchair, a white cane, a material, and the like) used together while each of the detection target actions is performed detected by the object recognition function may be set as the certainty factor of the detection result.

Herein, a specific example of the first association information in which a detection result and a notification destination are associated. In the specific example, the notification destination is assumed to include the facility worker terminal 40-1, the security terminal 40-2, the processing apparatus administrator terminal 40-3, the first ATM terminal 40-4, the second ATM terminal 40-5, and the digital signage 40-6.

### “Determination of Notification Destination, Based on Type of Detected Detection Target Action”

For example, in the first association information, it may be specified that, in a case where the detected detection target action is any of “talking on a mobile phone” and “an action of operating an ATM while talking on a mobile phone”, at least one of the facility worker terminal 40-1, the security terminal 40-2, and the notification destination terminal 40 for the ATM (the first ATM terminal 40-4 or the second ATM terminal 40-5) is determined as a notification destination.

By designating the facility worker terminal 40-1 and the security terminal 40-2 as the notification destination, a worker of the facility, a security guard, and the like can recognize the situation (a situation in which the above-described detection target action is detected). Then, the worker of the facility, the security guard, and the like rush to the site and talk to a person performing the action, and thereby prevention of an incident is achieved. Further, by designating the notification destination terminal 40 for the ATM being used by the person performing the detection target action as the notification destination, warning, alerting, and the like for the person performing the detection target action are achieved.

Further, in the first association information, it may be specified that, in a case where the detected detection target action is any of “moving using a wheelchair” and “moving using a white cane”, the facility worker terminal 40-1 is determined as the notification destination. By designating the facility worker terminal 40-1 as the notification destination, a worker of the facility can recognize the situation (a situation in which the above-described detection target action is detected). Then, the worker of the facility rushes to the site and assist a person performing the action, and thereby improvement of service quality, and the like are achieved.

Further, in the first association information, it may be specified that, in a case where the detected detection target action is “an action of showing an interest in a predetermined material placed in the facility”, the digital signage 40-6 near a person performing the action is determined as the notification destination. For example, the digital signage 40-6 being installed nearest to the camera 30 that has generated an image from which the target action is detected may be determined as the notification destination. The digital signage 40-6 being installed nearest to the predetermined camera 30 can be determined based on preliminarily registered information indicating an installation position of the camera 30 and preliminarily registered information indicating an installation position of the digital signage 40-6. By designating such a digital signage 40-6 as the notification destination, a person showing an interest in the predetermined material can be provided with appropriate information and the like related to the predetermined material.

Further, in the first association information, it may be specified that, as the notification destination, at least one of the processing apparatus administrator terminal 40-3 and the processing apparatus provider terminal 40-7 is determined as the notification destination, regardless of which detection target action is the detected detection target action. By designating the processing apparatus administrator terminal 40-3 and the processing apparatus provider terminal 40-7 as the notification destination for all data, reviewing a result of decision by the processing apparatus 10, validity of algorithm of the processing apparatus 10, whether modification and maintenance are needed, and the like can be decided appropriately.

“Determination of Notification Destination, Based on Position where Detected Detection Target Action is Performed”

For example, in the first association information, it may be specified that, in a case where the detected detection target action is any of “talking on a mobile phone” and “an action of operating an ATM while talking on a mobile phone” and a position where the detection target action is detected is away from an ATM (specifically, a position different from a position where a person is located while operating the ATM), the facility worker terminal 40-1 is determined as a notification destination. By designating the facility worker terminal 40-1 as the notification destination, a worker of the facility can recognize the situation (a situation in which the above-described detection target action is detected). Then, the worker of the facility rushes to the site and talks to a person performing the action, and thereby prevention of an incident is achieved.

Further, in the first association information, it may be specified that, in a case where the detected detection target action is any of “talking on mobile phone” and “an action of operating an ATM while talking on a mobile phone” and a position where the detection target action is detected is near an ATM (specifically, a position where a person is located while operating the ATM), the notification destination terminal 40 for the ATM (the first ATM terminal 40-4, the second ATM terminal 40-5, or the like) is determined as the notification destination. By designating the notification destination terminal 40 for the ATM being used by a person performing the detection target action as the notification destination, warning, alerting, and the like for the person performing the detection target action are achieved.

In this way, in a situation in which it is possible to directly warn and alert a person performing the detection target action (a situation in which the person is near the notification destination terminal 40), the person is directly warned and alerted, and in a situation in which it is impossible to directly warn and alert the person performing the detection target action (a situation in which the notification destination terminal 40 is not nearby), a worker of the facility is notified and thereby the worker can be prompted to take an action for the person.

“Determination of Notification Destination, Based on Time Length for which Detected Detection Target Action is Performed”

For example, in the first association information, it may be specified that, in a situation in which a time length for which an action of operating an ATM while talking on a mobile phone is performed is less than a threshold value, the notification destination terminal 40 for the ATM (the first ATM terminal 40-4, the second ATM terminal 40-5, or the like) is determined as a notification destination. Then, in the first association information, it may be specified that, in a case where a time length for which an action of operating an ATM while talking on a mobile phone is performed becomes equal or more than the threshold value, the facility worker terminal 40-1 is determined as the notification destination.

“Determination of Notification Destination, Based on Time at which Detected Detection Target Action is Performed”

For example, in the first association information, it may be specified that, in a case where a detection target action is detected during business hours of the facility, the facility worker terminal 40-1 is determined as a notification destination. As another example, it may be specified that, in a case where a detection target action is detected during the business hours of the facility, a notification destination is determined by using any of methods described above in “determination of notification destination, based on a type of detected detection target action” and “determination of notification destination, based on a position where the detected detection target action is performed”.

Further, in the first association information, it may be specified that, in a case where a detection target action is detected outside the business hours of the facility, at least one of the processing apparatus administrator terminal 40-3 and the processing apparatus provider terminal 40-7 is determined as the notification destination.

By notifying the detection result to an appropriate notification destination according to the situation during business hours, prevention of an incident, improvement of service quality, and the like are achieved. Further, since there is no visitor in the facility outside the business hours, the detection target action is not detected. In a case where the detection target action is nevertheless detected, there is a possibility that a malfunction and the like of the processing apparatus 10 occurs. Thus, by notifying an administrator or a provider of the processing apparatus 10 that the detection target action is detected outside the business hours, early detection of a malfunction of the processing apparatus 10, and the like are achieved.

### “Determination of Notification Destination, Based on Certainty Factor of Detection Result”

For example, in the first association information, it may be specified that, in a case where the detected detection target action is any of “talking on a mobile phone” and “an action of operating an ATM while talking on a mobile phone”, and a certainty factor is high (equal to or higher than a first reference revel), the security terminal 40-2 is determined as a notification destination.

Further, in the first association information, it may be specified that, in a case where the detected detection target action is any of “talking on a mobile phone” and “an action of operating an ATM while talking on a mobile phone”, and the certainty factor is medium (equal to or higher than a second reference level and less than the first reference level), at least one of the facility worker terminal 40-1, and the notification destination terminal 40 for the ATM (the first ATM terminal 40-4, the second ATM terminal 40-5, and the like) is determined as the notification destination.

Further, in the first association information, it may be specified that, for any certainty factor, at least one of the processing apparatus administrator terminal 40-3 and the processing apparatus provider terminal 40-7 is determined as the notification destination. By designating the processing apparatus administrator terminal 40-3 and the processing apparatus provider terminal 40-7 as the notification destination for all data, reviewing a result of decision by the processing apparatus 10, validity of algorithm of the processing apparatus 10, whether modification and maintenance are needed, and the like can be decided appropriately.

Returning back to FIG. 1, the notification unit 13 notifies the determined notification destination of detection of the detection target action. The notification destination terminal 40 being the notification destination outputs predetermined information in response to a notification from the notification unit 13.

Herein, a specific example of the information output by the notification destination terminal 40 is described. In the specific example, the notification destination includes the facility worker terminal 40-1, the security terminal 40-2, the processing apparatus administrator terminal 40-3, the first ATM terminal 40-4, the second ATM terminal 40-5, and the digital signage 40-6.

For example, the facility worker terminal 40-1, the security terminal 40-2, and the processing apparatus administrator terminal 40-3 output information indicating that a person performing the detection target action is detected. Further, the facility worker terminal 40-1, the security terminal 40-2, and the processing apparatus administrator terminal 40-3 may further output information indicating at least one of a type of the detected detection target action, a position where the detected detection target action is performed, a time length for which the detected detection target action is performed, a time at which the detected detection target action is performed, and a certainty factor of the detection result.

Further, the first ATM terminal 40-4 and the second ATM terminal 40-5 outputs predetermined warning information. For example, the first ATM terminal 40-4 and the second ATM terminal 40-5 may output warning sound via a speaker, or may output audio information for alerting about an incident such as a remittance fraud. Further, the first ATM terminal 40-4 and the second ATM terminal 40-5 may turn on a warning lamp, or may output information for alerting about an incident such as a remittance fraud, via a display.

Further, the digital signage 40-6 provides a person showing an interest in a predetermined material with appropriate information related to the predetermined material. For example, the digital signage 40-6 can output an advertisement, a guidance, information related to the predetermined material, and the like.

Further, the processing apparatus administrator terminal 40-3 and the processing apparatus provider terminal 40-7 output new data, specifically, information indicating that a new detection result is accumulated. Then, the processing apparatus administrator terminal 40-3 and the processing apparatus provider terminal 40-7 store the result of detection by the processing apparatus 10. Specifically, the processing apparatus administrator terminal 40-3 and the processing apparatus provider terminal 40-7 store a history of the result of detection by the processing apparatus 10. The history of the detection result includes at least one of the type of the detected detection target action, the position where the detected detection target action is performed, the time length for which the detected detection target action is performed, the time at which the detected detection target action is performed, and the certainty factor of the detection result.

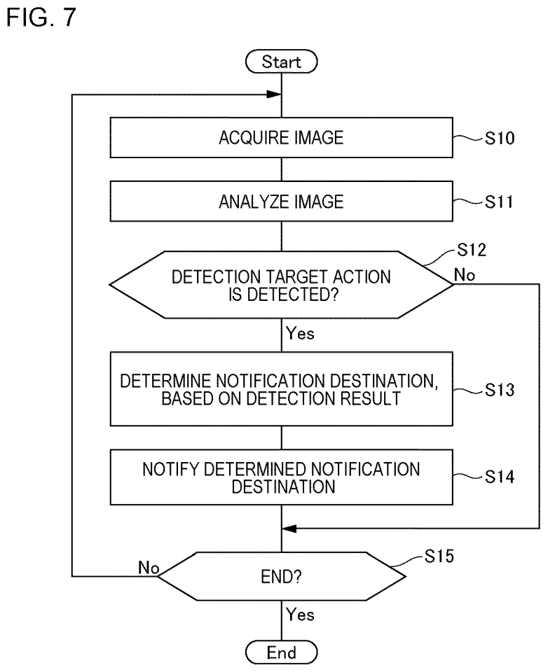

Next, one example of a flow of processing by the processing apparatus 10 is described with reference to a flowchart in FIG. 7.

After acquiring an image generated by the camera 30 (S10), the processing apparatus 10 analyzes the image, and detects that a target person captured in the image performs any of a plurality of detection target actions (S11).

In a case where the detection target action is detected (Yes in S12), the processing apparatus 10 determines a notification destination, based on a result of the detection in S10, specifically, at least one of a type of the detected detection target action, a position where the detected detection target action is performed, a time length for which the detected detection target action is performed, a time at which the detected detection target action is performed, and a certainty factor of the detection result (S13).

Then, the processing apparatus 10 notifies the notification destination determined in S13 of detection of the detection target action (S14). The notification destination terminal 40 being the notification destination to which detection of the detection target action is notified outputs predetermined information in response to the notification.

### Advantageous Effect

According to the processing apparatus 10 of the second example embodiment, a notification destination to which detection of a detection target action is notified can be determined based on at least one of a type of the detected detection target action, a position where the detected detection target action is performed, a time length for which the detected detection target action is performed, a time at which the detected detection target action is performed, and a certainty factor of a detection result. According to the processing apparatus 10 including such a configuration, an issue of notifying an appropriate notification destination according to detection of a person performing a predetermined action is solved.

Further, according to the processing apparatus 10 of the second example embodiment, it is possible to notify a predetermined notification destination, according to detection of talking on a mobile phone and an action of operating an ATM while talking on a mobile phone. Consequently, prevention of an incident, and the like are achieved.

Further, according to the processing apparatus 10 of the second example embodiment, it is possible to notify a predetermined notification destination, according to detection of moving using a wheelchair and moving using a white cane. Consequently, improvement of service quality, and the like are achieved by assisting such a visitor.

Further, according to the processing apparatus 10 of the second example embodiment, it is possible to notify a predetermined notification destination, according to detection of an action of showing an interest in a predetermined material placed in a facility. Consequently, improvement of service quality, and the like are achieved by providing a person showing an interest in the predetermined material with appropriate information related to the predetermined material.

Further, according to the processing apparatus 10 of the second example embodiment, an appropriate notification destination according to a detection result can be determined from among the notification destination terminals 40 such as the facility worker terminal 40-1, the security terminal 40-2, the processing apparatus administrator terminal 40-3, the first ATM terminal 40-4, the second ATM terminal 40-5, the digital signage 40-6, the processing apparatus provider terminal 40-7, and the like. By determining the appropriate notification destination from among such a variety of the notification destination terminals 40, prevention of an incident, improvement of service quality provided by the facility, and the like are effectively achieved.

### Third Example Embodiment

A processing apparatus 10 according to a third example embodiment includes a function of acquiring operation information indicating an operation content of an ATM, and determining a notification destination for detection of a detection target action, based on the operation information. Details are described in the following.

A facility in the third example embodiment is a facility in which an ATM is installed. Further, an image to be processed by an action analysis unit 11 includes an image capturing a user of the ATM (an image captured by a first ATM camera 30-1 and an image captured by a large two ATM camera 30-2).

The action analysis unit 11 performs processing of acquiring operation information indicating an operation content of the ATM, in addition to the processing described in the first and second example embodiments. The operation information includes at least any of a transaction content (transfer, withdrawal, deposit, bankbook entry, and the like), and a transaction amount. The action analysis unit 11 acquires such operation information from the ATM or from a banking system or a post office system interworking with the ATM.

A determination unit 12 determines a notification destination for detection of a detection target action, based on the above-described operation information. As in the second example embodiment, the determination unit 12 determines a notification destination, based on first association information generated in advance. In the following, a specific example of the first association information is described.

For example, in the first association information, it may be specified that, in a case where the detected detection target action is “an action of operating an ATM while talking on a mobile phone” and the transaction content is transfer and the transaction amount (transfer amount) is equal to or more than a predetermined amount, a facility worker terminal 40-1 and a security terminal 40-2 are determined as notification destinations. By designating not only the facility worker terminal 40-1 but also the security terminal 40-2 as the notification destinations in a case of high importance in which the transaction amount is relatively large, a security guard and a security organization (security company and the like) can response quickly, and thus prevention of an incident and early resolution of an incident are expected.

Further, in the first association information, it may be determined that, in a case where the detected detection target action is “an action of operating an ATM while talking on a mobile phone” and the transaction content is transfer and the transaction amount (transfer amount) is less than the predetermined amount, the facility worker terminal 40-1 is determined as the notification destination. By refraining from notifying the security terminal 40-2 in a case of low importance in which the transaction amount is relatively small, an excessive workload on the security guard and the security organization (security company and the like) can be reduced.

Further, in the first association information, it may be specified that, in a case where the detected detection target action is “an action of operating an ATM while talking on a mobile phone” and the transaction content is a content different from transfer, the facility worker terminal 40-1 and the security terminal 40-2 are not determined as notification destinations. In a case where the transaction content is not transfer, it is likely not a remittance fraud. By refraining from unnecessary notification to the facility worker terminal 40-1 and the security terminal 40-2, an excessive workload on a worker of the facility, the security guard, and the security organization (security company and the like) can be reduced.

Other configurations of the processing apparatus 10 according to the third example embodiment are similar to those of the processing apparatus 10 in the first and second example embodiments.

According to the processing apparatus 10 of the third example embodiment, an advantageous effect similar to that of the processing apparatus 10 in the first and second example embodiments is achieved. Further, according to the processing apparatus 10 of the third example embodiment, a notification destination for detection of a detection target action can be determined based on an operation content of an ATM. According to such a processing apparatus 10, unnecessary notification to the facility worker terminal 40-1 and the security terminal 40-2 can be suppressed. Consequently, an excessive workload on a worker of a facility, a security guard, and a security organization (security company and the like) can be reduced.

### Fourth Example Embodiment

A processing apparatus 10 according to a fourth example embodiment includes a function of determining an additional notification content to be notified in addition to detection of a detection target action, based on a result of detecting the detection target action. Details are described in the following.

A determination unit 12 determines an additional notification content to be notified in addition to “detection of a detection target action”, based on at least one of a type of the detected detection target action, a position where the detected detection target action is performed, a time length for which the detected detection target action is performed, a time at which the detected detection target action is performed, and a certainty factor of a detection result. Then, a notification unit 13 notifies the determined notification destination of the determined “additional notification content” in addition to the “detection of the detection target action”. A notification destination terminal 40 can output the notified additional notification content and notify a user.

The additional notification content includes at least one of an image capturing a scene in which the detection target action is performed, information indicating a basis for deciding that the detection target action is performed, age of a person whose action is detected as the detection target action, gender of the person whose action is detected as the detection target action, an external appearance feature of the person whose action is detected as the detection target action, whether the person whose action is detected as the detection target action has a companion, information indicating a content of a past transaction by the person whose action is detected as the detection target action, and a current position of the person whose action is detected as the detection target action.

The “image capturing a scene in which the detection target action is performed” is an image capturing a person performing the detection target action. By including such an image in the additional notification content, a person who receives a notification can easily recognize the person performing the detection target action. Further, by including such an image in the additional notification content, a person who receives a notification can confirm whether the detection target action is actually performed.

The “information indicating a basis for deciding that the detection target action is performed” is a result of decision of a pose and a motion by an image analysis system 20. In the following, a specific example of information included in the decision result is described.

First, the image analysis system 20 can decide a pose and a motion by using the technique disclosed in Patent Document 3. In this case, the image analysis system 20 computes a similarity between a template image indicating each of a plurality of poses and motions registered in advance, and a pose and a motion of a target person captured in an image, and searches for a template image of which a similarity to the pose and the motion of the target person captured in the image satisfies a predetermined condition (e.g., a similarity to a template image being a positive example is equal to or higher than a predetermined level, a similarity to a template image being a negative example is lower than the predetermined level, and the like). Then, the pose and the motion indicated by the template image of which the similarity satisfies the predetermined condition are decided as a pose and a motion performed by the target person.

In this example, a result of decision of the pose or the motion by the image analysis system 20 includes information indicating a type of the pose and the motion decided to be performed by the target person, the template image of which the similarity satisfies the predetermined condition, and the similarity to the template image, and the like. Note that, in a case where there are a plurality of template images of which the similarities satisfy the predetermined condition, the decision result may include the plurality of template images and a similarity to each of the template images.

By including such information in the additional notification content, a person who receives the notification can confirm whether the detection target action is actually performed (validity of a detection result).

The “age of the person whose action is detected as the detection target action”, the “gender of the person whose action is detected as the detection target action”, and the “external appearance feature of the person whose action is detected as the detection target action” can be determined by analyzing an image generated by a camera 30, by using a well-known technique. The external appearance feature of the person whose action is detected as the detection target action is a feature of clothing and belongings.

By including such information in the additional notification content, a person who receives the notification can easily determine a person performing the detection target action.

“Whether the person whose action is detected as the detection target action has a companion” can be determined for example, by deciding “whether there is a person pushing a wheelchair (a condition of a companion)”, “whether there is a person moving together with the person whose action is detected as the detection target action while touching the person (another condition of a companion)”, and the like, by analyzing an image generated by the camera 30.

By including such information in the additional notification content, a person who receives the notification can decide whether assistance is needed for a person performing the detection target action.

The “information indicating a content of a past transaction by the person whose action is detected as the detection target action” is acquired from a database and the like of a bank or a post office. In a case where the person whose action is detected as the detection target action can be identified (an individual can be determined) based on a content of an operation on an ATM, face authentication based on an image generated by the camera 30, or the like, a content of a past (e.g., latest) transaction by the person stored in the database and the like of the bank or the post office can be retrieved, and can be set as the additional notification content.

By including such information in the additional notification content, it is possible to provide a person who receives the notification with a basis for deciding whether the person performing the detection target action is being subjected to a remittance fraud.

The “current position of the person whose action is detected as the detection target action” can be determined by tracking the person in an image generated by the camera 30, and by searching for, by using a face authentication technique, the person in an image generated by the camera 30.

By including such information in the additional notification content, a person who receives the notification can easily recognize a current position of a person performing the detection target action.

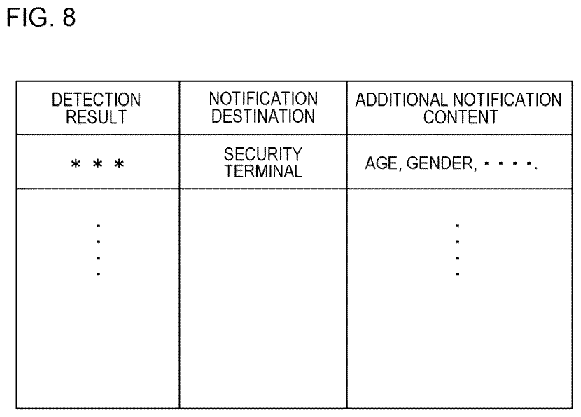

The determination unit 12 can determine an additional notification content for each determined notification destination. In advance, second association information in which a detection result, a notification destination, and an additional notification content are associated is generated as illustrated in FIG. 8, and is stored in the processing apparatus 10. The determination unit 12 determines, based on a result of detection by the action analysis unit 11, a determined notification destination, and the second association information, an additional notification content for each detection result.

Herein, a specific example of the second association information is described. Note that, the example described herein is merely one example, and is not limited thereto. In the specific example, the notification destination includes a facility worker terminal 40-1, a security terminal 40-2, a processing apparatus administrator terminal 40-3, a first ATM terminal 40-4, a second ATM terminal 40-5, and a digital signage 40-6.

In the second association information, it may be specified that, in a case where a detected detection target action is “an action of operating an ATM while talking on a mobile phone” and the determined notification destination is the first ATM terminal 40-4 or the second ATM terminal 40-5, the additional notification content is not included. In this case, for example, only a content described in the second and third example embodiments is notified to the first ATM terminal 40-4 or the second ATM terminal 40-5.

Further, in the second association information, it may be specified that, in a case where the detected detection target action is “an action of operating an ATM while talking on a mobile phone” and the determined notification destination includes at least one of the facility worker terminal 40-1 and the security terminal 40-2, the image capturing a scene in which the detected detection target action is performed is determined as the additional notification content.

Further, in the second association information, it may be specified that, in a case where the detected detection target action is “an action of operating an ATM while talking on a mobile phone” and the determined notification destination includes at least one of the processing apparatus administrator terminal 40-3 and a processing apparatus provider terminal 40-7, the image capturing a scene in which the detected detection target action is performed and the information indicating a basis for deciding that the detection target action is performed are determined as the additional notification contents.

Further, in the second association information, it may be specified that, in a case where the detected detection target action is “an action of showing an interest in a predetermined material placed in a facility” and the determined notification destination is the digital signage 40-6, the external appearance feature of the person whose action is detected as the detection target action is determined as the additional notification content.

Further, in the second association information, it may be specified that, in a case where the detected detection target action is “an action of showing an interest in the predetermined material placed in the facility” and the determined notification destination is the facility worker terminal 40-1, the image capturing a scene in which the detection target action is performed is determined as the additional notification content.

Further, in the second association information, it may be specified that, in a case where the detected detection target action is “an action of showing an interest in the predetermined material placed in the facility” and the determined notification destination includes at least one of the processing apparatus administrator terminal 40-3 and the processing apparatus provider terminal 40-7, the image capturing a scene in which the detected detection target action is performed and the information indicating a basis for deciding that the detection target action is performed are determined as the additional notification contents.

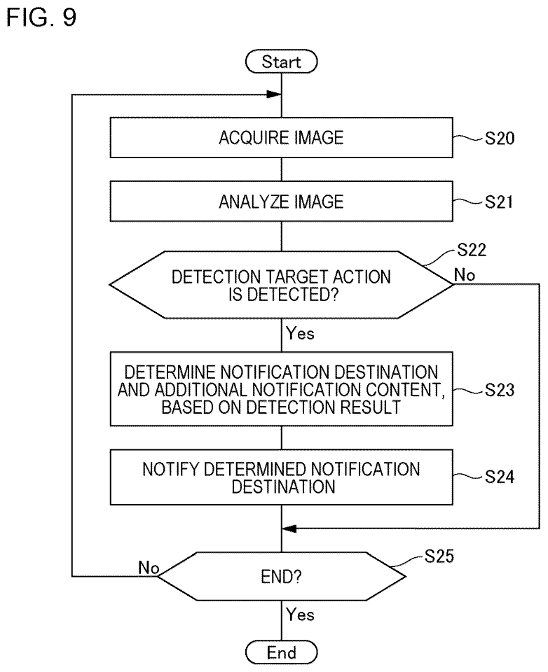

Next, one example of a flow of processing by the processing apparatus 10 is described with reference to a flowchart in FIG. 9.

After acquiring an image generated by the camera 30 (S20), the processing apparatus 10 analyzes the image, and detects that a target person captured in the image performs any of a plurality of detection target actions (S21).

In a case where the detection target action is detected (Yes in S22), the processing apparatus 10 perform processing in S23. In S23, the processing apparatus 10 determines a notification destination, based on a result of the detection in S20, specifically, at least one of a type of the detected detection target action, a position where the detected detection target action is performed, a time length for which the detected detection target action is performed, a time at which the detected detection target action is performed, and a certainty factor of the detection result. Further, in S23, the processing apparatus 10 determines an additional notification content, based on the result of the detection in S20, specifically, at least one of the type of the detected detection target action, the position where the detected detection target action is performed, the time length for which the detected detection target action is performed, the time at which the detected detection target action is performed, and the certainty factor of the detection result, and the determined notification destination.

Then, the processing apparatus 10 notifies the notification destination determined in S23 of detection of the detection target action and the additional notification content determined in S23 (S24). The notification destination terminal 40 being the notification destination to which detection of the detection target action is notified outputs predetermined information in response to the notification.

Other configurations of the processing apparatus 10 according to the fourth example embodiment are similar to the configuration of the processing apparatus 10 in the first to third example embodiments.

According to the processing apparatus 10 of the fourth example embodiment, an advantageous effect similar to that of the processing apparatus according to the first to third example embodiments is achieved. Further, according to the processing apparatus 10 of the fourth example embodiment, an appropriate additional notification content can be notified according to a detection result and a notification destination. Consequently, appropriate information can be notified to the notification destination while suppressing inconvenience of notifying excessive information.

### Fifth Example Embodiment

In a fifth example embodiment, variations in various processing performed by a processing system are described. The processing system can employ one of the variations described in the following. Further, the processing system can employ a combination of a plurality of the variations described in the following in combination.

### —Image Capture by First ATM Camera 30-1 and Second ATM Camera 30-2—

A first ATM camera 30-1 and a second ATM camera 30-2 may capture a moving image continuously during a predetermined time period (e.g., while a facility is open, while an ATM is operating, and the like). Alternatively, the first ATM camera 30-1 and the second ATM camera 30-2 may capture a still image in response to detection of a predetermined trigger. Alternatively, the first ATM camera 30-1 and the second ATM camera 30-2 may capture a moving image, in response to detection of the predetermined trigger, for a predetermined time from a time that the predetermined trigger is detected.

The predetermined trigger is detection of a predetermined operation performed on an ATM. The predetermined operation is insertion of a card into the ATM, insertion of a bankbook into the ATM, a predetermined input via an input apparatus (a touch panel, an operation button, and the like) of the ATM, and the like. The predetermined input may be, for example, an input for initiating a transfer procedure.

### —Image Capture by Camera 30—

A camera 30 may capture a still image at a predetermined time interval (e.g., every one minute) determined in advance. Further, in a case where a person in a predetermined pose (e.g., a phone call pose, a pose while in a wheelchair, and a pose while using a white cane) is detected in the still image, the camera 30 may capture a moving image from that time point.

### —Image Selection by Action Analysis Unit 11—

First, the camera 30 captures a moving image. Further, the action analysis unit 11 may set all frame images included in the moving image as processing targets, and perform processing of detecting a detection target action.

Alternatively, the action analysis unit 11 may select some of a plurality of frame images included in the moving image, set only the selected frame images as processing targets, and perform the processing of detecting a detection target action.

As a method for selecting some of the frame images, for example, the action analysis unit 11 may select a frame image captured at timing that the “predetermined trigger” described above in “image capture by first ATM camera 30-1 and second ATM camera 30-2” is detected. Alternatively, the action analysis unit 11 may select frame images for a predetermined time from the frame image captured at the timing that the above-described predetermined trigger is detected.

Alternatively, the action analysis unit 11 may select a frame image of a predetermined time interval (e.g., every predetermined number of frame images) determined in advance. Further, in a case where a person in the predetermined pose (e.g., the phone call pose, the pose while in a wheelchair, the pose while using a white cane) is detected in the frame image selected in this way, the action analysis unit 11 may select consecutive frame images for a predetermined time from that time point.

### —Data to be Registered in Image Analysis System 20—

First, an image analysis system 20 can decide a pose and a motion by using the technique disclosed in Patent Document 3. In this case, the image analysis system 20 computes a similarity between a template image indicating each of a plurality of poses and motions registered in advance, and a pose and a motion of a target person captured in an image, and searches for a template image of which a similarity to the pose and the motion of the target person captured in the image satisfies a predetermined condition. Further, a pose and a motion indicated by the template image of which the similarity satisfies the predetermined condition are decided as a pose and a motion of the target person. In the following, variations of this processing by the image analysis system 20 are described.

The template image may be a positive example, negative example, or may be both. The positive example is a pose and a motion while performing a predetermined detection target action. The negative example is not a pose and a motion while performing the predetermined detection target action, but is a pose and a motion similar to the pose and the motion while performing the predetermined detection target action. For example, in a case where the predetermined detection target action is “talking on a mobile phone”, a phone call pose and the like are exemplified as the positive example, and an upright standing pose, a head scratching pose, and the like are exemplified as the negative example.

Further, in addition to the registered pose, a weight of each body part used in collation may be registered. Collation using a weight of each body part is disclosed in Patent Document 3.

Further, in addition to the registered pose, an essential requirement for collation with the template image may be registered. An image that does not satisfy the essential requirement is not collated with the template image. The essential requirement may be specified for each pose and each motion. For example, as an essential requirement for collation with a template image indicating the phone call pose, “a hand of a target person is captured in an image” and the like may be defined. In a case where a hand of a target person is not captured in an image, it is meaningless to collate the image with the template image, since it cannot be decided whether to be talking on a phone. By collating only an image that satisfies the essential requirement with the template image, unnecessary collation can be avoided, and a load on a computer can be reduced.

### —First Pose and Motion Decision Processing by Image Analysis System 20—

First, both a positive example and a negative example are registered for each pose and each motion being a detection target. A plurality of positive examples and a plurality of negative examples are registered in association with a pose or a motion being one detection target.

In a case where an analysis target image matches with at least one positive example, the image analysis system 20 may decide that a target person in the analysis target image performs a pose and a motion indicated by the matched positive example.

Alternatively, in a case where the analysis target image matches with at least one negative example, the image analysis system 20 may decide that a target person in the analysis target image does not perform a pose and a motion being detection targets that are similar to a pose and a motion of the matched negative example.

Alternatively, in a case where the analysis target image matches with both of a positive example and a negative example, the image analysis system 20 may decide according to the number of matches for each. For example, in a case where the number of matches with the positive example is greater than the number of matches with the negative example, the image analysis system 20 may decide that the target person in the analysis target image performs a pose and a motion indicated by the matched positive example. On the other hand, in a case where the number of matches with the negative example is greater than the number of matches with the positive example, the image analysis system 20 may decide that the target person in the analysis target image does not perform a pose and a motion being detection targets that are similar to a pose and a motion of the matched negative example.

Alternatively, in a case where the analysis target image matches with both of a positive example and a negative example of a first pose (or a first motion), the image analysis system 20 may decide based on a similarity between the analysis target image and a template image.

For example, in a case where a template image of which a similarity to the analysis target image is the highest is a positive example, the image analysis system 20 may decide that the person in the analysis target image performs the first pose (or the first motion). On the other hand, in a case where the template image of which the similarity to the analysis target image is the highest is a negative example, the image analysis system 20 may decide that the target person in the analysis target image does not perform the first pose (or the first motion).

As another example, the image analysis system 20 may decide based on a magnitude correlation between a “statistical value (an average value, a maximum value, a minimum value, a mode value, a median value, and the like) of similarities of positive examples that match with the analysis target image, among the positive examples of the first pose (or the first motion)” and a “statistical value of similarities of negative examples that match with the analysis target image, among the negative examples of the first pose (or the first motion)”.

For example, in a case where the statistical value of the positive example is greater, it may be decided that the target person in the analysis target image performs a pose and a motion indicated by the matched positive example. On the other hand, in a case where the statistical value of the negative example is greater, the image analysis system 20 may decide that the target person in the analysis target image does not perform a pose and a motion being detection targets that are similar to a pose and a motion of the matched negative example.

As a modification example of this example, the “statistical value of similarities of positive examples that match with the analysis target image, among the positive examples of the first pose (or the first motion)” may be substituted for a “statistical value of similarities of all the positive examples of the first pose (or the first motion)”. Further, the “statistical value of similarities of negative examples that match with the analysis target image, among the negative examples of the first pose (or the first motion)” may be substituted for a “statistical value of similarities of all the negative examples of the first pose (or the first motion).

Alternatively, the image analysis system 20 may decide a pose and a motion of the target person by using another technique such as machine learning.

### —Second Pose and Motion Decision Processing by Image Analysis System 20—

The image analysis system 20 decides a pose and a motion of a target person, based on a plurality of images. The plurality of images may be a plurality of still images generated in a plurality of times of image capture, or may be a plurality of frame images generated in capturing a moving image.

Further, in a case where it is decided by the plurality of times of decision based on the plurality of images that a predetermined pose or motion is performed at least once, the image analysis system 20 may decide that the target person captured in the images performs the pose or the motion.

Alternatively, in a case where it is decided by the plurality of times of decision based on the plurality of images that the predetermined pose or motion is performed equal to or more than a predetermined proportion (specifically, N or more times out of M times), the image analysis system 20 may decide the target person captured in the images performs the pose or the motion.

Alternatively, in a case where it is decided by the plurality of times of decision based on the plurality of images that the predetermined pose or motion is consecutively performed equal to or more than a predetermined Q times, the image analysis system 20 may decide that the target person captured in the images performs the pose or the motion.

Alternatively, the image analysis system 20 may decide by weighting a decision result for each of the plurality of images.

### —Third Pose and Motion Decision Processing by Image Analysis System 20—

In a case where a plurality of persons are captured in an image generated by the first ATM camera 30-1 and the second ATM camera 30-2, the image analysis system 20 can determine a person who is captured largest in the image as a target person, and perform decision of a pose and a motion. Further, a person in the image may be tracked using a face and a pose, and a person who is continuously captured in the image may be decided as a target person. Further, the image analysis system 20 may interwork with an ATM, and determine timing from a start of a transaction to an end of the transaction, then, the image analysis system 20 may determine a person who is captured in the image for the longest time between the start of the transaction to the end of the transaction as a target person.

Further, the image analysis system 20 may decide peeking on an operation on the ATM, based on the number of persons other than the target person, orientation of a face, a size of the face, and the like.

### —Information Output by Digital Signage 40-6—

A digital signage 40-6 may output information that is related to a material in which a target person shows an interest and is determined based on various attributes of the target person. The various attributes of the target person may be determined by an image analysis generated by the camera 30. Alternatively, an individual may be determined based on a card or a bankbook inserted into the ATM, and information (an address and the like) registered in a bank system or a post office system in association with the individual in advance may be used as information indicating an attribute of the target person.

Alternatively, an action history of a target person determined by tracking the target person in an image generated by the camera 30 may be used as the information indicating an attribute of the target person. Note that, a plurality of the cameras 30 can be used in conjunction while tracking the target person.

### —Use of Detection Result—

A processing apparatus 10 may compute, based on a result of detecting each of a plurality of detection target actions, a tendency that each of the detection target action appears. For example, the processing apparatus 10 may compute a situation for each case by dividing the cases by time of a day, a day of a week, a store, and the like and then performing statistical processing. Based on a result of the computation, a facility can take a measure such as increasing the number of workers in a specific case and playing an audio that warns of a remittance fraud.

### —Output by Notification Destination Terminal 40—

In a case where an image capturing a scene in which a detected detection target action is performed is included in an additional notification content and the image is a moving image, a notification destination terminal 40 may output a moving image from timing that is predetermined time before timing at which the detection target action is detected, as the additional notification content.

Other configurations of the processing system according to the fifth example embodiment are similar to the configurations of the processing system in the first to fourth example embodiments.

According to the processing system of the fifth example embodiment, an advantageous effect similar to that of the processing system according to the first to fourth example embodiments is achieved. Further, according to the processing system of the fifth example embodiment, each of the variations can be employed, which is desirable because a degree of freedom in design is increased thereby.

While the example embodiments of the present invention have been described with reference to the drawings, the example embodiments are exemplifications of the present invention, and various configurations other than the above-described configuration may also be employed. Configurations of the above-described example embodiments may be combined with each other or some of the configurations may be replaced with other configurations. Further, the configurations of the above-described example embodiments may be added with various modifications to an extent that does not depart from the scope of the present invention. Further, a configuration and processing disclosed in each of the above-described example embodiments and the modification examples may be combined with each other.

Further, in a plurality of flowcharts referred to in the above description, a plurality of steps (pieces of processing) are described in order, but an execution order of the steps executed in each example embodiment is not limited to the described order. In each example embodiment, the illustrated order of the steps may be changed to an extent that contents thereof are not interfered. Further, each of the above-described example embodiments may be combined to an extent that contents thereof do not conflict with each other.

A part or the entirety of the above-described example embodiments may be described as the following supplementary notes, but is not limited thereto.

1. A processing apparatus including:
an action analysis unit that detects that a target person captured in an image capturing a person in a facility performs any of a plurality of detection target actions;
a determination unit that determines a notification destination, based on at least one of a type of the detected detection target action, a position where the detected detection target action is performed, a time length for which the detected detection target action is performed, a time at which the detected detection target action is performed, and a certainty factor of a detection result; and
a notification unit that notifies the determined notification destination of detection of the detected target action.
   2. The processing apparatus according to supplementary note 1, wherein
the determination unit determines the notification destination, based on at least two of a type of the detected detection target action, a position where the detected detection target action is performed, a time length for which the detected detection target action is performed, a time at which the detected detection target action is performed, and a certainty factor of a detection result.
   3. The processing apparatus according to supplementary note 1, wherein
the determination unit determines the notification destination, based on at least three of a type of the detected detection target action, a position where the detected detection target action is performed, a time length for which the detected detection target action is performed, a time at which the detected detection target action is performed, and a certainty factor of a detection result.
   4. The processing apparatus according to supplementary note 1, wherein
the determination unit determines the notification destination, based on a type of the detected detection target action, a position where the detected detection target action is performed, a time length for which the detected detection target action is performed, a time at which the detected detection target action is performed, and a certainty factor of a detection result.
   5. The processing apparatus according to any one of supplementary notes 1 to 4, wherein
an automatic teller machine (ATM) is installed in the facility,
the image includes an image capturing a user of an ATM,
the action analysis unit acquires operation information indicating a content of operation on an ATM, and
the determination unit determines a notification destination for detection of the detection target action, further based on the operation information.
   6. The processing apparatus according to supplementary note 5, wherein
the operation information includes at least one of a transaction content and a transaction amount.
   7. The processing apparatus according to any one of supplementary notes 1 to 6, wherein
the detection target action includes at least one of talking on a mobile phone, an action of operating an ATM while talking on a mobile phone, moving using a wheelchair, moving using a white cane, and an action of showing an interest in a predetermined material placed in the facility.
   8. The processing apparatus according to any one of supplementary notes 1 to 7, wherein
the notification destination includes at least one of a terminal for a worker of the facility, a security terminal, a terminal for an administrator who manages the processing apparatus, a terminal for a visitor that is installed in the facility and outputs information toward a person in the facility, and a terminal for a provider that has provided the processing apparatus.
   9. The processing apparatus according to any one of supplementary notes 1 to 8, wherein
the determination unit determines an additional notification content to be notified in addition to detection of the detection target action, based on at least one of a type of the detected detection target action, a position where the detected detection target action is performed, a time length for which the detected detection target action is performed, a time at which the detected detection target action is performed, and a certainty factor of a detection result, and
the notification unit notifies the determined notification destination of the determined additional notification content.
   10. The processing apparatus according to supplementary note 9, wherein
the additional notification content includes at least one of the image capturing a scene in which the detected detection target action is performed, information indicating a basis for deciding that the detection target action is performed, age of a person whose action is detected as the detection target action, gender of a person whose action is detected as the detection target action, an external appearance feature of a person whose action is detected as the detection target action, whether a person whose action is detected as the detection target action has a companion, information indicating a content of a past transaction by a person whose action is detected as the detection target action, and a current position of a person whose action is detected as the detection target action.
   11. The processing apparatus according to supplementary note 9 or 10, wherein
the determination unit determines the additional notification content for each of the notification destinations.
   12. A processing method including,
by a computer:
detecting that a target person captured in an image capturing a person in a facility performs any of a plurality of detection target actions;
determining a notification destination, based on at least one of a type of the detected detection target action, a position where the detected detection target action is performed, a time length for which the detected detection target action is performed, a time at which the detected detection target action is performed, and a certainty factor of a detection result; and
notifying the determined notification destination of detection of the detection target action.
   13. A storage medium storing a program causing a computer to function as:
an action analysis unit that detects that a target person captured in an image capturing a person in a facility performs any of a plurality of detection target actions;
a determination unit that determines a notification destination, based on at least one of a type of the detected detection target action, a position where the detected detection target action is performed, a time length for which the detected detection target action is performed, a time at which the detected detection target action is performed, and a certainty factor of a detection result; and
a notification unit that notifies the determined notification destination of detection of the detected target action.

### REFERENCE SIGNS LIST

10 Processing apparatus
11 Action analysis unit
12 Determination unit
13 Notification unit
20 Image analysis system
30 Camera
40 Notification destination terminal
1A Processor
2A Memory
3A Input/output I/F
4A Peripheral circuit
5A Bus

What is claimed is:

1. A processing apparatus comprising:
at least one memory configured to store one or more instructions; and
at least one processor configured to execute the one or more instructions to:
detect that a target person captured in an image capturing a person in a facility performs any of a plurality of detection target actions;
determine a notification destination, based on at least one of a type of the detected detection target action, a position where the detected detection target action is performed, a time length for which the detected detection target action is performed, a time at which the detected detection target action is performed, and a certainty factor of a detection result; and
notify the determined notification destination of detection of the detection target action.

2. The processing apparatus according to claim 1, wherein
the at least one processor is further configured to execute the one or more instructions to determine the notification destination, based on at least two of a type of the detected detection target action, a position where the detected detection target action is performed, a time length for which the detected detection target action is performed, a time at which the detected detection target action is performed, and a certainty factor of a detection result.

3. The processing apparatus according to claim 1, wherein
the at least one processor is further configured to execute the one or more instructions to determine the notification destination, based on at least three of a type of the detected detection target action, a position where the detected detection target action is performed, a time length for which the detected detection target action is performed, a time at which the detected detection target action is performed, and a certainty factor of a detection result.

4. The processing apparatus according to claim 1, wherein
the at least one processor is further configured to execute the one or more instructions to determine the notification destination, based on a type of the detected detection target action, a position where the detected detection target action is performed, a time length for which the detected detection target action is performed, a time at which the detected detection target action is performed, and a certainty factor of a detection result.

5. The processing apparatus according to claim 1, wherein
an automatic teller machine (ATM) is installed in the facility,
the image includes an image capturing a user of an ATM,
the at least one processor is further configured to execute the one or more instructions to
acquire operation information indicating a content of operation on an ATM, and
determine a notification destination for detection of the detection target action, further based on the operation information.

6. The processing apparatus according to claim 5, wherein
the operation information includes at least one of a transaction content and a transaction amount.

7. The processing apparatus according to claim 1, wherein
the detection target action includes at least one of talking on a mobile phone, an action of operating an ATM while talking on a mobile phone, moving using a wheelchair, moving using a white cane, and an action of showing an interest in a predetermined material placed in the facility.

8. The processing apparatus according to claim 1, wherein
the notification destination includes at least one of a terminal for a worker of the facility, a security terminal, a terminal for an administrator who manages the processing apparatus, a terminal for a visitor that is installed in the facility and outputs information toward a person in the facility, and a terminal for a provider that has provided the processing apparatus.

9. The processing apparatus according to claim 1, wherein the at least one processor is further configured to execute the one or more instructions to
determine an additional notification content to be notified in addition to detection of the detection target action, based on at least one of a type of the detected detection target action, a position where the detected detection target action is performed, a time length for which the detected detection target action is performed, a time at which the detected detection target action is performed, and a certainty factor of a detection result, and
notify the determined notification destination of the determined additional notification content.

10. The processing apparatus according to claim 9, wherein
the additional notification content includes at least one of the image capturing a scene in which the detected detection target action is performed, information indicating a basis for deciding that the detection target action is performed, age of a person whose action is detected as the detection target action, gender of a person whose action is detected as the detection target action, an external appearance feature of a person whose action is detected as the detection target action, whether a person whose action is detected as the detection target action has a companion, information indicating a content of a past transaction by a person whose action is detected as the detection target action, and a current position of a person whose action is detected as the detection target action.

11. The processing apparatus according to claim 9, wherein
the at least one processor is further configured to execute the one or more instructions to determine the additional notification content for each of the notification destinations.

12. A processing method comprising,
by a computer:
detecting that a target person captured in an image capturing a person in a facility performs any of a plurality of detection target actions;
determining a notification destination, based on at least one of a type of the detected detection target action, a position where the detected detection target action is performed, a time length for which the detected detection target action is performed, a time at which the detected detection target action is performed, and a certainty factor of a detection result; and
notifying the determined notification destination of detection of the detection target action.

13. A non-transitory storage medium storing a program causing a computer to:
detect that a target person captured in an image capturing a person in a facility performs any of a plurality of detection target actions;
determine a notification destination, based on at least one of a type of the detected detection target action, a position where the detected detection target action is performed, a time length for which the detected detection target action is performed, a time at which the detected detection target action is performed, and a certainty factor of a detection result; and
notify the determined notification destination of detection of the detected target action.

14. The processing method according to claim 12, wherein
the computer determines the notification destination, based on at least two of a type of the detected detection target action, a position where the detected detection target action is performed, a time length for which the detected detection target action is performed, a time at which the detected detection target action is performed, and a certainty factor of a detection result.

15. The processing method according to claim 12, wherein
the computer determines the notification destination, based on at least three of a type of the detected detection target action, a position where the detected detection target action is performed, a time length for which the detected detection target action is performed, a time at which the detected detection target action is performed, and a certainty factor of a detection result.

16. The processing method according to claim 12, wherein
the computer determines the notification destination, based on a type of the detected detection target action, a position where the detected detection target action is performed, a time length for which the detected detection target action is performed, a time at which the detected detection target action is performed, and a certainty factor of a detection result.

17. The processing method according to claim 12, wherein
an automatic teller machine (ATM) is installed in the facility,
the image includes an image capturing a user of an ATM,
the computer
acquires operation information indicating a content of operation on an ATM, and
determines a notification destination for detection of the detection target action, further based on the operation information.

18. The non-transitory storage medium according to claim 13, wherein
the program causing the computer to determine the notification destination, based on at least two of a type of the detected detection target action, a position where the detected detection target action is performed, a time length for which the detected detection target action is performed, a time at which the detected detection target action is performed, and a certainty factor of a detection result.

19. The non-transitory storage medium according to claim 13, wherein
the program causing the computer to determine the notification destination, based on at least three of a type of the detected detection target action, a position where the detected detection target action is performed, a time length for which the detected detection target action is performed, a time at which the detected detection target action is performed, and a certainty factor of a detection result.

20. The non-transitory storage medium according to claim 13, wherein
the program causing the computer to determine the notification destination, based on a type of the detected detection target action, a position where the detected detection target action is performed, a time length for which the detected detection target action is performed, a time at which the detected detection target action is performed, and a certainty factor of a detection result.
